(19) United States
(12) Patent Application Publication
(10) Pub. No.: US 2006/0274003 A1
(43) Pub. Date: Dec. 7, 2006

(54) Liquid crystal display device

(76) Inventors: Yuichi Inoue, Kameyama-shi (JP); Takahiro Sasaki, Taki-gun (JP)

Correspondence Address: HARNESS, DICKEY & PIERCE, P.L.C., P.O. BOX 8910, RESTON, VA, 20195, US

(21) Appl. No.: 11/441,231

(22) Filed: May 26, 2006

(30) Foreign Application Priority Data
May 27, 2005 (JP) 2005-155104

(51) Int. Cl. G09G 3/36

(52) U.S. Cl. 345/87

(57) ABSTRACT

In a layer of liquid crystals of a liquid crystal panel, polymer is formed which causes liquid crystal molecules to be tilted in a predetermined direction when no voltage is applied; a control circuit includes a display signal output section and a display signal monitor section; the display signal output section inputs digital display signals RGB, and outputs display signals to a data driver at predetermined timings; and the display signal monitor section monitors changes of display signals for every frame, and controls the display signal output section to cause the display signal output selection to output a gray voltage to a data bus line before supplying a white or halftone display voltage, when a display signal changes from a black display to a white or halftone display signal.

### CROSS-REFERENCE TO RELATED APPLICATIONS

This application is based on and claims priority of Japanese Patent Application No.2005-155104 filed on May 27, 2005, the entire contents of which are incorporated herein by reference.

### BACKGROUND OF THE INVENTION

1. Field of the Invention

The present invention relates to a liquid crystal display device which is used for a display for personal computer, a television set, a projector (a projection type), and the like, and particularly to a liquid crystal display device which has excellent response characteristics and is preferable in displaying moving images.

2. Description of the Prior Art

Liquid crystal display devices have the advantages that they are thin and light and that they can be operative at low voltages and have low power consumption. Accordingly, liquid crystal display devices are widely used in various kinds of electronic devices. In particular, active matrix liquid crystal display devices in which a thin film transistor (TFT) is provided as a switching element for each picture element show excellent display characteristics, which are comparable to those of cathode-ray tube (CRT) displays, and therefore have come to be used not only for displays for personal computers, but also for televisions, projectors, and the like.

A usual liquid crystal display device has a structure in which liquid crystals are sealed between two substrates being disposed to face each other. On one substrate, TFT's, picture element electrodes, and the like are formed, while color filters, a common electrode, and the like are formed on the other substrate. Hereinafter, one substrate on which TFT's, picture element electrodes and the like are formed is referred to as a TFT substrate; and the other substrate, which is disposed to face the TFT substrate, is referred to as an opposing substrate. A structure formed by sealing liquid crystals between the TFT substrate and the opposing substrate is referred to as a liquid crystal panel. Polarizing plates are disposed respectively on both sides of a liquid crystal panel in the thickness direction thereof. By applying a voltage between a picture element electrode and a common electrode, the alignment state of liquid crystal molecules is changed so that the amount of light passing through these polarizing plates can be adjusted.

Heretofore, twisted nematic (TN) liquid crystal display devices have been widely used in which liquid crystals with positive dielectric anisotropy are sealed between two substrates and in which liquid crystal molecules are twisted and aligned. However, TN liquid crystal display devices have the disadvantage that viewing angle characteristics are poor and that contrast and color tone change to a large extent when the screen is viewed from an oblique direction. Accordingly, multi-domain vertical alignment (MVA) liquid crystal display devices, which have favorable viewing angle characteristics, have been developed and put into practical use.

Incidentally, conventional liquid crystal display devices have the problem that response characteristics are not sufficient, and an after image occurs when displaying moving images. Therefore, to improve the response characteristics, various kinds of research works have been conducted.

In general, given that a transmittance in the period of a white display is set to 100%, response characteristics of liquid crystal display devices are defined by time tr (hereinafter, referred to as rise time) which is required for a transmittance to change from 10% to 90%, and by time tf (hereinafter, referred as fall time) which is required for a transmittance to change from 90% to 10%. It is known that each of the rise time tr and the fall time tf will be shortened when a cell gap is made small. Thus, in a current liquid crystal display device, a cell gap tends to decrease.

However, in a current liquid crystal display device, an after image sometimes occurs, for example, when changing from a black display (which means, hereinafter, a display in the lowest tone) to a halftone display or when changing from a black display to a white display (which means, hereinafter, a display in the highest tone); and hence further improvement to the response characteristics has been required.

To improve the response characteristics of a liquid crystal display device, improving of liquid crystal materials may be considered. However, liquid crystal materials have not been obtained which show sufficient response characteristics when used in a liquid crystal display device and which satisfies both a display performance and maintaining reliability during a long period.

A driving method of a liquid crystal display device is a storage method in which a display signal (a display voltage) is written in a liquid crystal capacitance being constituted by a picture element electrode, a common electrode, and liquid crystals therebetween. In a usual liquid crystal display device, an auxiliary capacitance Cs is formed to be in parallel to a liquid crystal capacitance to restrain the lowering of an applied voltage occurring due to the dielectric anisotropy of liquid crystals. Increase of a capacitance value of this auxiliary capacitance Cs may be considered to improve the response characteristics. However, in general, an electrode constituting the auxiliary capacitance Cs is formed of metal, and hence when an electrode is made large to increase the capacitance value, an aperture ratio is decreased and accordingly the screen becomes dark.

A technology so-called overdrive in improving the response characteristics has been developed on the basis of driving techniques. This technology is to accelerate the state change of liquid crystal molecules by changing a voltage in three steps from a black display voltage (a low voltage) to a white display voltage (a high voltage) to a halftone display voltage (an intermediate voltage), when changing from a black display to a halftone display. However, although the overdrive can shorten the response time when changing from a black display to a halftone display, it cannot shorten the response time when changing from a black display to a white display since a higher voltage than that in the period of a white display cannot be applied.

It is described in Japanese Patent Application Laid-open No. 2004-310113 that when changing from a black display to a white display or a halftone display, an intermediate voltage (hereinafter, referred to as a gray voltage) between a black display voltage and a white display voltage or a halftone display voltage is applied during a short period of time (for example, the period of one frame). The driving method as described above in which a gray voltage is applied between a black display and a white display or a halftone display is referred to as a gray insertion method in this application.

A reason why the response time is shortened by the gray insertion method is described hereinafter. Incidentally, in this application, an angle formed by a normal line perpendicular to the substrate surface and the major axis of a liquid crystal molecule is referred to as a tilt angle, and the direction of a line the line being one formed when projecting the major axis of a liquid crystal molecule on the substrate surface is referred to as a tilt orientation.

In an MVA liquid crystal display device, since liquid crystals with negative dielectric anisotropy are used, liquid crystal molecules are aligned in a direction perpendicular to the substrate surface (or the surface of an alignment film) during the period of a black display. When applying a voltage to a picture element electrode, liquid crystal molecules in the vicinity of a structure (a protrusion, a slit, or the like) for alignment control are tilted at a tilt angle in accordance with an applied voltage in a tilt orientation which is determined depending on the structure for alignment control. On the other hand, liquid crystal molecules in a region away from structures for alignment control are tilted at an angle in accordance with a voltage right after application of the voltage, and however they come to an unstable state since the tilt orientation is not determined, and are tilted in a predetermined orientation after the propagating of the tilt orientation from liquid crystal molecules in the vicinity of structures for alignment control, come to a stable state. Accordingly, it takes a long time for all the liquid crystal molecules within a picture element to tilt in predetermined angles and come to a stable state after an application of a voltage.

When a gray voltage is applied between a black display and a white display or a halftone display, for example, during the period of one frame (approximately 16 ms), liquid crystal molecules being perpendicularly aligned are slightly pretilted in an orientation determined depending on structures for alignment control. The tilt orientation is also propagated to liquid crystal molecules in regions away from structures for alignment control within the period of one frame, and almost all the liquid crystal molecules within a picture element are pretilted in predetermined tilt orientations. Then, when a white display voltage or a halftone display voltage is applied, since tilt orientations of liquid crystal molecules are already determined, the liquid crystal molecules within the picture element are tilted all together at once in predetermined orientations and at tilt angles in accordance with a display voltage. Thus, the rise time tr is shortened.

However, the gray insertion method disclosed in Japanese Patent Application Laid-open No. 2004-310113 does not provide sufficient response characteristics, and hence still further improvement is required. Especially, in a liquid crystal display device having a small cell gap (for example, 3 μm or less), liquid crystal molecules in gaps quickly respond to random orientations and block the propagating of tilt orientations so that a sufficient effect of the gray insertion method cannot be obtained.

### SUMMARY OF THE INVENTION

In light of the above, an object of the present invention is to provide a liquid crystal display device which has good response characteristics as compared with the conventional one and which is suitable for displaying moving images.

The above described problems can be solved by a liquid crystal display device including a first substrate and a second substrate facing to each other; a layer of liquid crystals formed of liquid crystals being sealed between the first substrate and the second substrate; a pretilt means for tilting liquid crystal molecules in a predetermined direction when no voltage is applied; an electrode for applying a voltage to the layer of liquid crystals and changing an alignment state of liquid crystal molecules; a display signal output section for supplying display signals to the electrode; and a display signal monitor section for monitoring a change of the display signals for every frame, and for controlling the display signal output section and thus causing the display signal output section to supply the electrode with a third voltage being a medium one between a first voltage and a second voltage before supplying the second voltage thereto, when a display signal changes from the first voltage to the second voltage being higher than the first voltage.

The inventors of the present application conducted various kinds of experiments and research work to further improve response characteristics of a liquid crystal display device, especially, having a small cell gap. As a result, the inventors found out that even in a liquid crystal display device having a small cell gap, the rise time can be reduced by combining the pretilt means causing liquid crystal molecules to be tilted in a predetermined direction when no voltage is applied and the gray insertion method. The present invention was made based on such findings.

The liquid crystal display device of the present invention includes a display signal monitor section for monitoring a change of the display signals for every frame, and for controlling the display signal output section and thus causing the display signal output control section to supply the electrode with a third voltage (e.g. a gray voltage) being a medium one between a first voltage (e.g. a black display voltage) and a second voltage (e.g. a white voltage or a halftone voltage) before supplying the second voltage thereto, when a display signal changes from the first voltage to the second voltage being higher than the first voltage. The liquid crystal display device of the present invention further includes the pretilt means which causes liquid crystal molecules to be tilted in a predetermined direction when no voltage is applied. This enables the shortening of the rise time even for a liquid crystal display device having a small cell gap.

As the pretilt means, polymer formed in a layer of liquid crystals can be used. This polymer can be formed in such a way that, for example, monomer is added in liquid crystals in advance; the liquid crystals are sealed between the first substrate and the second substrate, and thereafter a voltage is applied to an electrode to cause liquid crystal molecules to be aligned in a predetermined direction, and monomer is polymerized by an irradiation of ultraviolet, an application of heating, or the like. The pretilt means can also be an alignment film on which a rubbing process is performed or ultraviolet is irradiated.

Incidentally, in Japanese Patent Application Laid-open No. 2003-149647, it is described that a pretilt angle is provided with polymer formed in liquid crystals. However, in the present invention, response time can be drastically shortened compared to the case where polymer is only formed in liquid crystals.

### BRIEF DESCRIPTION OF THE DRAWINGS

FIG. 1 is a block diagram showing the entire constitution of a liquid crystal display device of an embodiment of the present invention.

FIG. 2 is a plan view showing one picture element of a liquid crystal panel.

FIG. 3 is a schematic sectional view of the same.

FIG. 4 is a block diagram showing a constitution of a control circuit.

FIG. 5 is a view showing one example of transmittance-applied voltage characteristics (T-V characteristics) for a liquid crystal display device.

FIG. 6 is a schematic diagram showing the changes of output voltages to data bus lines at a time when changing from a black display to a white display.

FIG. 7 is a schematic diagram showing an evaluation cell.

FIG. 8 is a plan view showing a modified example of a liquid crystal display device.

### DESCRIPTION OF THE PREFERRED EMBODIMENTS

The present invention is described hereinafter with reference to the accompanying drawings.

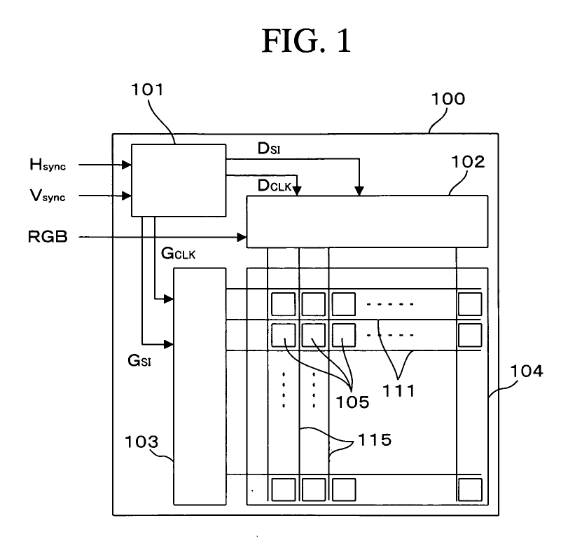

FIG. 1 is a block diagram showing the entire constitution of a liquid crystal display device of an embodiment of the present invention. The present embodiment shows an example that the present invention is applied to an MVA liquid crystal display device.

A liquid crystal display device 100 of the present embodiment includes a control circuit 101, a data driver 102, a gate driver 103, and a liquid crystal panel 104. To this liquid crystal display device 100, a digital display signals RGB, horizontal synchronization signals Hsync, vertical synchronization signals Vsync, and the like are supplied from an external device (not shown) such as a computer.

In the liquid crystal panel 104, a plurality of picture elements 105 are arranged in matrix. Furthermore, in the liquid crystal panel 104, there are provided a plurality of data bus lines 115 extending in the vertical direction, and a plurality of gate bus lines 111 extending in the horizontal direction. In a liquid crystal display device of the present embodiment, the gate bus lines 111 and the data bus lines 115 become borders for respective picture elements 105. Details of the picture elements 105 are described later.

The control circuit 101 inputs a horizontal synchronization signal Hsync and a vertical synchronization signal Vsync, and outputs a data start signal DSI becoming active at the time of start during one horizontal synchronization period, a data clock DCLK dividing one horizontal synchronization period into fixed intervals, a gate start signal GSI becoming active at the time of start during one vertical synchronization period, and a gate clock GCLK dividing one vertical synchronization period into fixed intervals.

The data driver 102 converts digital display signals RGB input from an external device into analog display signals, and supplies the analog display signals to the respective data bus lines 115 for every one horizontal synchronization period at timings based on data start signals DSI and data clocks DCLK input from the control circuit 101. The control circuit 101 and the data bus driver 102 monitor the display signals RGB as described later, and supply a gray voltage to the data bus lines 115 during the period of one frame only, to a picture element which is changed from a black display to a white display or a halftone display.

On the other hand, the gate driver 103 causes scanning signals being supplied to the respective gate bus lines 111 to be active in turn with a cycle of a horizontal synchronization period, within one vertical synchronization period, based on the gate start signals GSI and the gate clock GCLK input from the control circuit 101.

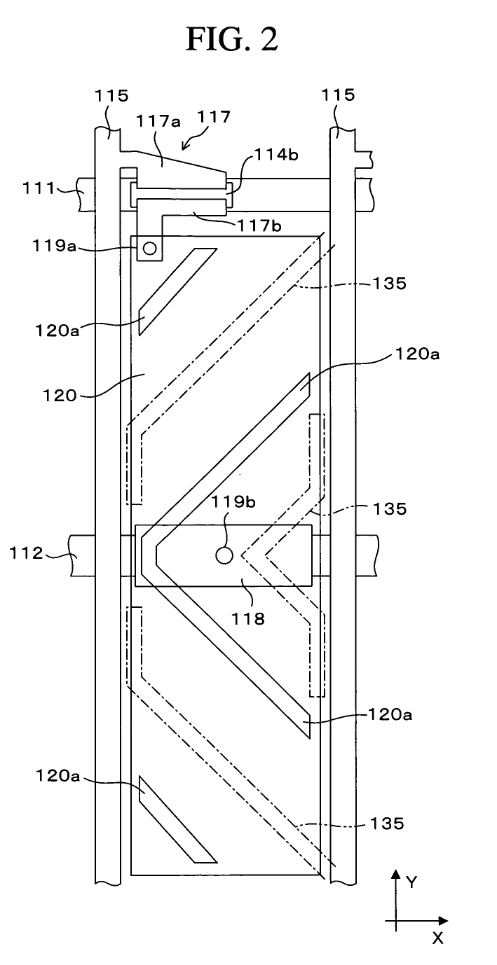

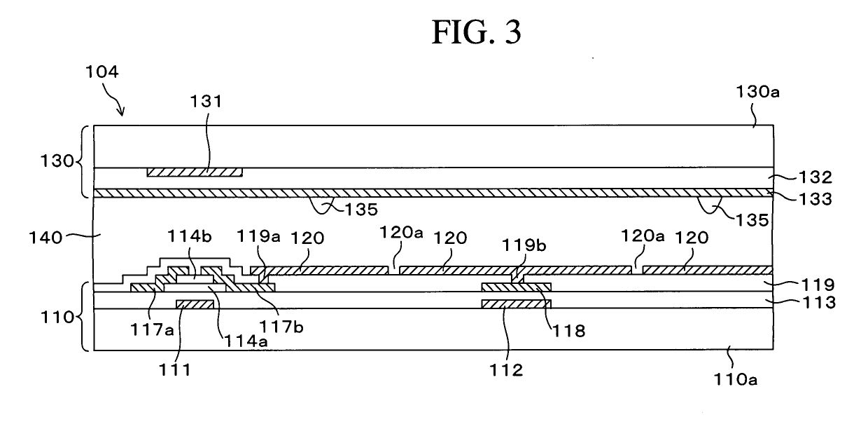

FIG. 2 is a plan view showing the liquid crystal panel 104, and FIG. 3 is a schematic sectional view of the same. Note that, FIG. 2 shows a region for one picture element. In practice, a large number of picture elements 105 are arranged in matrix in the horizontal direction (in the direction of X-axis) and in the vertical direction (in the direction of Y-axis).

As shown in FIG. 3, the liquid crystal panel 104 is constituted by a TFT substrate 110, an opposing substrate 130, and a layer of liquid crystals 140 formed of liquid crystals with negative dielectric anisotropy being sealed between the TFT substrate 140 and the opposing substrate 130. In the layer of liquid crystals 140, polymer is formed to cause liquid crystal molecules to be pretilted. This polymer, as described later, is formed by polymerizing a polymerization constituent (monomer or oligomer) added in liquid crystals.

Incidentally, as a method of pretilting liquid crystal molecules, a method of performing a rubbing process on an alignment film, a method of irradiating ultraviolet on an alignment film from a predetermined direction, and the like are known other than the method of forming polymer in a layer of liquid crystals as described above. In the present invention too, instead of the method of forming the polymer in a layer of liquid crystals, these methods may be adopted.

Polarizing plates (not shown) are respectively disposed on the front side (the observer's side; the upper side in FIG. 3) of the liquid crystal panel 104 and the back side (the lower side in FIG. 3) thereof, and further a backlight is disposed on the back side. One polarizing plate is disposed in a way that its absorption axis coincides with the X-axis shown in FIG. 2, and the other polarizing plate is disposed in a way that its absorption axis coincides with the Y-axis.

As shown in FIG. 2, on a glass substrate 110a which becomes a base for the TFT substrate 110, there are formed a plurality of gate bus lines 111 extending in the horizontal direction (in the direction of X-axis) and a plurality of data bus lines 115 extending in the vertical direction (in the direction of Y-axis). The gate bus lines 111 are placed in the vertical direction at intervals of, for example, approximately 300 μm, and the data bus lines 115 are placed in the horizontal direction at intervals of, for example, approximately 100 μm. Rectangular regions divided by the gate bus lines 111 and the data bus lines 115 are picture element regions, respectively. On the TFT substrate 110, an auxiliary capacitance bus line 112 is formed which is placed in parallel to the gate bus lines 111 and which crosses a picture element region in the middle thereof.

On the TFT substrate 110, a TFT 117, an auxiliary capacitance electrode 118, and a picture element electrode 120 are formed for each picture element region. For the TFT 117, part of the gate bus line 111 is caused to work as a gate electrode. As shown in FIG. 3, a semiconductor film 114a, which becomes an active layer for the TFT 117, and a channel protection film 114b are formed over the above described gate electrode; and a drain electrode 117a and a source electrode 117b are placed on both sides of the semiconductor film 114a to face each other. The drain electrode 117a is connected to the data bus line 115.

The auxiliary capacitance electrode 118 is formed at a position where the auxiliary capacitance electrode 118 faces the auxiliary capacitance bus line 112 with a first insulating film 113 interposed therebetween. An auxiliary capacitance Cs is constituted by this auxiliary capacitance electrode 118, the auxiliary capacitance bus line 112, and the first insulting film 113 interposed therebetween.

The picture element electrode 120 is formed of transparent conductive material such as indium-tin oxide (ITO). Slits 120a, extending in an oblique direction relative to the direction of Y-axis, are provided to the picture element electrode 120 as alignment control structures. The slits 120a are approximately symmetrically formed on the upper and lower sides with respect to a center line of the auxiliary capacitance bus line 112.

A second insulating film 119 is formed between the gate bus lines 115, the TFT 117, the auxiliary capacitance electrode 118a, and the picture element electrode 120. The picture element electrode 120 is electrically connected to the source electrode 117b and the auxiliary capacitance electrode 118 through contact holes 119a and 119b formed in the second insulating film 119. The surface of the picture element electrode 120 is covered with a vertical alignment film (not shown) formed of, for example, polyimide.

Over (under in FIG. 3) the glass substrate 130a which becomes a base of the opposing substrate 130, there are formed a black matrix (a light blocking film) 131, a color filter 132, a common electrode 133, and bank-like protrusions 135 being alignment control structures. The black matrix 131 is formed of metal such as Cr (chromium) or black resin, and is placed at a position where the black matrix 131 faces the gate bus lines 111, the data bus lines 115, and the TFT 117 on the side of the TFT substrate 110. There are color filters 132 of three different colors, i.e. red (R), green (G), and blue (B). A color filter of any one color among red, green, and blue is placed in each picture element. The common electrode 133 is formed of a transparent conductive material such as ITO, and is formed on (below in FIG. 3) the color filter 132. The bank-like protrusions 135 are formed of a dielectric material such as resin. These protrusions 135 are formed to be parallel to the slits 120a of the picture element electrode 120 at positions away from the slits 120a, as shown in FIG. 2. The surfaces of the common electrode 133 and the protrusions 135 are covered with a vertical alignment film formed (not shown) of, for example, polyimide.

A method of manufacturing the liquid crystal display device of the present embodiment is described hereinafter with reference to FIGS. 2 and 3.

First, the glass substrate 110a which becomes a base of the TFT substrate 110 is prepared. On this glass substrate 110a, a metal film formed by laminating, for example, aluminum (Al)/titan (Ti) is formed. This metal film is patterned by photolithography to form the gate bus lines 111 and the auxiliary capacitance bus lines 112.

The first insulating film (a gate insulating film) 113 made of an insulating material such as, for example, SiO₂, or SiN is formed on the entire upper surface of the glass substrate 110a. The semiconductor film (an amorphous silicon film or a polysilicon film) 114a which becomes an active layer for the TFT 117 is formed on a predetermined region of the first insulating film 113.

Subsequently, an SiN film is formed on the entire upper surface of the glass substrate 110a, and patterned by photolithography to form the channel protection film 114b on a region which becomes a channel for the semiconductor film 114a.

On the entire upper surface of the glass substrate 110a, an ohmic contact layer (not shown) is formed which is made with a semiconductor film containing impurities in high density. Then, Ti, Al, and Ti are laminated in this order on the glass substrate 110a to form a metal film. This metal film and the ohmic contact layer are patterned by photolithography to form the data bus lines 115, the drain electrode 117a, the source electrode 117b, and the auxiliary capacitance electrode 118.

Next, the second insulating film 119 made with an insulating material such as, for example, SiO₂, or SiN is formed on the entire upper surface of the glass substrate 110a. On this second insulating film 119, the contact hole 119a leading to the source electrode 117b, and the contact hole 119b leading to the auxiliary capacitance electrode 118 are formed.

ITO is sputtered on the entire upper surface of the glass substrate 110a to form an ITO film. This ITO film is electrically connected to the source electrode 117b and the auxiliary capacitance electrode 118 through the contact holes 119a and 119b. Thereafter, the ITO film is patterned by photolithography to form a picture element electrode 120 having the slits 120a.

Polyimide is applied to the entire upper surface of the glass substrate 110a to form an alignment film. In this way, the TFT substrate 110 is completed.

Next, a method of manufacturing the opposing substrate 130 is described.

First, the glass substrate 130a which becomes a base of the opposing substrate 130 is prepared. On a predetermined region of the glass substrate 130a, the black matrix 131 is formed with black resin or metal such as Cr. This black matrix 131 is formed at a position where the black matrix 131 faces the gate bus line 111, the data bus line 115 and the TFT 117.

Next, red photosensitive resin, green photosensitive resin, and blue photosensitive resin are used to form red, green, and blue color filters 132 on the glass substrate 130a.

Then, ITO is sputtered on the entire upper surface of the glass substrate 130a to form the common electrode 133. Thereafter, photosensitive resin is applied to the common electrode 133, and this photosensitive resin is subjected to exposure and development processes to form the protrusions 135.

Next, polyimide is applied to form an alignment film which covers the surfaces of the common electrode 133 and the protrusions 135. In this manner, the opposing substrate 130 is completed.

The TFT substrate 110 and the opposing substrate 130 manufactured in this way are disposed to face each other with spacers (not shown) interposed therebetween, and liquid crystals with negative dielectric anisotropy are sealed between the TFT substrate 110 and the opposing substrate 130 to constitute the liquid crystal panel 104. In liquid crystals, a polymerization constituent such as, for example, diacrylate is added in advance. The distance (a cell gap) between the TFT substrate 110 and the opposing substrate 130 is set to, for example, 2.5 to 3 μm.

Next, a predetermined signal is applied to the gate bus lines 111 to set a TFT 117 in an ON state for each picture element, and a voltage is further applied to the data bus lines 115 to align liquid crystal molecules in a predetermined direction which is determined by the structures (the slits 120a and the protrusions 135) for alignment control. Then, after the alignment state of liquid crystal molecules becomes stable, ultraviolet is irradiated to polymerize the polymerization constituent added in the liquid crystals and to form polymer which regulates the alignment direction of liquid crystal molecules at the time when a voltage is applied. With this polymer, liquid crystal molecules are slightly tilted in the predetermined direction even at the time when no voltage is applied. It is preferred that a pretilt angle (an angle formed by the major axis of a liquid crystal molecule and the substrate surface) be not less than 87° and less than 90°. When the pretilt angle is less than 87°, transmittance in the period of a black display is increased, and the contrast characteristics are lowered.

Note that, a thermosetting polymerization constituent may be used instead of a light (including ultraviolet) curing polymerization constituent. In addition, a pretilt angle may be provided using the method of performing a rubbing process on an alignment film or the method of irradiating ultraviolet on an alignment film from a predetermined direction, instead of forming polymer in the layer of liquid crystals, as described previously.

Operations of the liquid crystal display device of the present embodiment are described hereinafter.

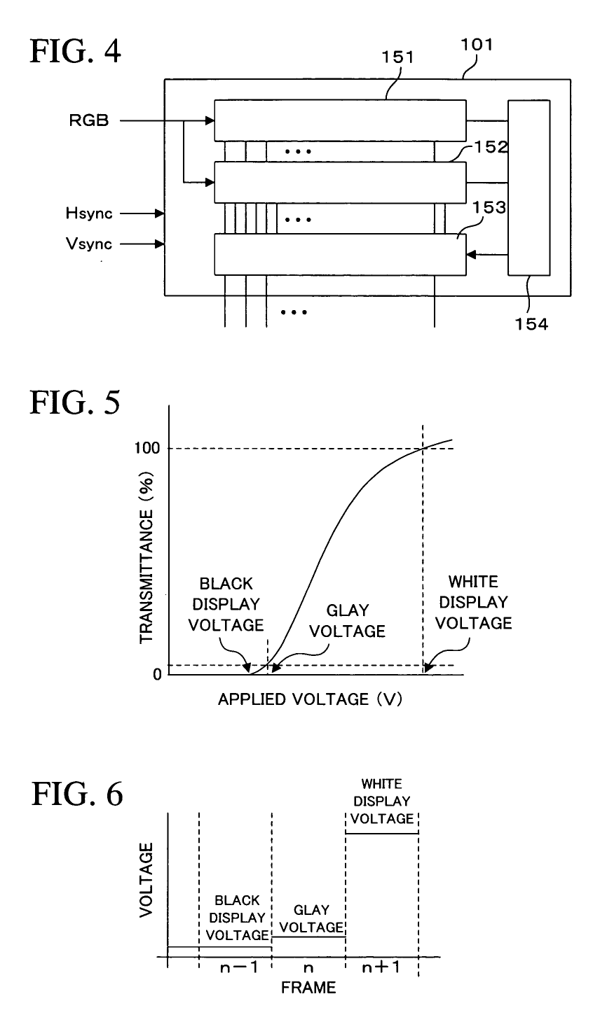

As shown in FIG. 4, the control circuit 101 includes a first frame buffer 151 storing digital display signals RGB of odd-numbered frames; a second frame buffer 152 storing digital display signals RGB of even-numbered frames; a display signal output section 153 converting digital display signals RGB into display signals and outputting the display signals thus converted to the data driver 102; and a display signal monitor section 154 monitoring changes of display signals for every picture element with display signals stored in the frame buffers 151 and 152.

The display signal output section 153 inputs display signals from the first frame buffer 151 for the odd-numbered frames, and inputs display signals from the second frame buffer 152 for even-numbered frames. The display signal output section 153 outputs the display signals to the data driver 102 for every horizontal synchronization period at timings based on the gate start signal DSI and the data clock signal DCLK.

On the other hand, the gate driver 103 causes scanning signals of the gate bus lines 111 to be active in turn within the period of one frame at a step of one horizontal synchronization period, based on gate start signals GSI and gate clock signals GCLK.

For example, when a scanning signal of a first gate bus line 111 becomes active, a TFT 117 of a picture element (a picture element on a first line) connected to the gate bus line 111 is turned ON, and a display signal (a display voltage) is written in the picture element electrode 120. Thereafter, although the scanning signal becomes non-active and the TFT 117 is turned OFF, the display signal is retained in the picture element electrode 120 and the auxiliary capacitance electrode 118.

Subsequently, a scanning signal of a second gate bus line 111 becomes active; a TFT 117 of a picture element (a picture element on a second line) connected to the gate bus line 111 is turned ON; and a display signal (a display voltage) is written in the picture element electrode 120. Thereafter, although the scanning signal becomes non-active and the TFT 117 is turned OFF, the display signal is retained in the picture element electrode 120 and the auxiliary capacitance electrode 118.

In this way, display signals are written in respective picture elements of the liquid crystal panel 104 for every frame. For a picture element where a display signal has been written, liquid crystal molecules are tilted at an angle in accordance with the voltage of the display signal. At this time, since the direction in which liquid crystal molecules fall is regulated with polymer formed in the layer 140 of liquid crystals, liquid crystal molecules within a picture element are tilted in a predetermined direction simultaneously with the applying of a voltage. An amount of light in accordance with a tilt angle of liquid crystal molecules transmits a picture element.

The display signal monitor section 154 monitors the change of display signals of the respective picture elements with display signals stored in the first frame buffer 151 and display signals stored in the second frame buffer 152. When a picture element, which has changed from a black display to a white display or a halftone display close to a white display, is detected, the display signal output section 153 is controlled and a gray voltage is applied to the picture element during the period of one frame only, when a display signal is written in the picture element.

FIG. 5 is a view showing one example of transmittance-applied voltage characteristics (T-V characteristics) for a liquid crystal display device with voltages applied to a picture element electrode on the horizontal axis and transmittances on the vertical axis. It is preferred that a gray voltage be one such that transmittance is of the order of 1 to 10% of a transmittance in the period of a white display. When a gray voltage is excessively high, a gray display is perceived between a black display and a white display or halftone display, which causes one a sense of discomfort, and hence it is necessary to select the most suitable gray voltage by viewing the display of moving images.

FIG. 6 is a view showing the changes of output voltages to the data bus lines at the time when changing from a black display to a white display. Note that, in a usual liquid crystal display device, the polarities of display signals are reversed for every frame, and however the reversals of the polarities of display signals are not hereinafter for the sake of simplifying description.

For example, in the case where a picture element which displays black up to the nth (n is an arbitrary integer) frame displays white in the (n+1)th frame, the display signal monitor section 154 controls the display signal output section 153 and makes a gray voltage output when outputting a display signal of the nth frame.

In the period of a black display, liquid crystal molecules almost perpendicularly face the substrate surface (the surface of an alignment film). By applying a gray voltage, liquid crystal molecules are slightly tilted in a predetermined direction being determined with polymer. When applying, in the next frame, a white display voltage or a halftone display voltage close to a white display voltage, the liquid crystal molecules are tilted at a tilt angle in accordance with an applied voltage. When applying a white display voltage or a halftone display voltage close to a white display voltage, the time required for liquid crystal molecules to be aligned in a predetermined direction is shortened compared with the time when a gray voltage is not applied. That is because the liquid crystal molecules have been already tilted in the predetermined direction.

Description is hereinafter made with respect to results obtained on effects of the present invention by manufacturing and using a liquid crystal display device for evaluation (an evaluation cell).

Firstly, two glass substrates were prepared, and ITO was sputtered thereon to form transparent electrodes. Then, the transparent electrodes of the respective glass substrates were patterned by photolithography to respectively form a plurality of parallel slits (structures for alignment control). Next, polyimide manufactured by JSR Corporation was, thereafter, applied to the respective glass substrates to form alignment films.

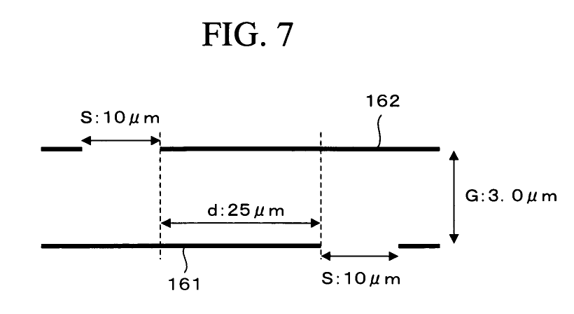

These glass substrates were placed to face each other with spacers interposed therebetween, and in between these glass substrates liquid crystals (manufactured by Merck Ltd; Δe=−3.8, NI point=70° C.) in which 1 wt % of light-polymerized monomer was added were sealed to form a liquid crystal panel. As shown in FIG. 7, the cell gap G of this liquid crystal panel was 3.0 μm; the width S of a slit was 10 μm; and the distance d between a slit of a lower transparent electrode 161 and a slit of an upper transparent electrode 162 is 25 μm.

Next, after a voltage was applied between transparent electrodes to align liquid crystal molecules in a predetermined direction, ultraviolet was irradiated to polymerize monomer, and polymer was formed. With this polymer, a pretilt angle of liquid crystal molecules at the time when no voltage was applied was set to 89°. Polarizing plates are, thereafter, placed on both sides of the liquid crystal panel to create an evaluation cell.

Using the evaluation cell formed in this way, as an Embodiment 1, a black display voltage was set to 0.8 V and a white display voltage was set to 5.5 V, and the rise time tr at the time when changing from a black display to a white display was measured. Note that, a voltage was applied thereto as a gray voltage during the period of one frame only. The voltage was equivalent to 1% of the transmittance during the white display.

In addition, as a Comparative Example, using the above evaluation cell, the rise time tr at the time when changing from a black display to a white display with no gray voltage applied was measured.

Moreover, as a Conventional Example 1, an evaluation cell was manufactured which is the same as the Embodiment other than no polymer was formed in a layer of liquid crystals, and the rise time tr at the time when changing from a black display to a white display was measured. Note that, when changing from a black display to a white display, a voltage where transmittance was 1% of that in the period of a white display was applied as a gray voltage during the period of one frame only.

Still further, as a Conventional Example 2, using the same evaluation cell as the Conventional Example 1, the rise time tr at the time when changing from a black display to a white display with no gray voltage applied was measured.

These results are tabulated as shown in Table 1 below.

TABLE 1

| | | Gray | |
|---|---|---|---|
| | Polymer | Voltage | Rise |
| | Existed | Inserted | Time |
| Embodiment | YES | YES | 1.7 ms |
| Comparative Example | YES | NO | 3.5 ms |
| Conventional Example 1 | NO | YES | 10 ms |
| Conventional Example 2 | NO | NO | 14 ms |

As shown in this Table 1, the rise time tr of the Conventional Example 1 in which polymer for providing a pretilt angle was not formed was 10 ms, and the rise time tr of the Conventional Example 2 in which a gray voltage was not inserted was 14 ms. The rise time tr of the Conventional Example 1 in which a gray voltage was inserted was improved by about 30% in comparison to that of the Conventional Example 2 in which a gray voltage was not inserted.

On the other hand, the rise time of the Embodiment was 1.7 ms, and that of the Comparative Example in which a gray voltage was not inserted was 3.5 ms. From the above, it can be seen that the rise times of the Embodiment and the Comparative Example in which polymer was formed are drastically shortened compared with those of the Conventional Examples 1 and 2. In addition, the rise time of the Embodiment was improved by about 45% compared with that of the Comparative Example, confirming that the present invention is extremely effective for the improvement of the response time.

Incidentally, although, in the above experiments, the distance between the slits (structures for alignment control) is set to 25 μm, it may be set to 30 μm or larger. In recent years, the panel sizes of liquid crystal display devices tend to become large. In this case, the sizes of picture elements become large so that it is inevitable that the distance between structures for alignment control become large. When the distance between structures for alignment control exceeds 30 μm, an alignment regulation force by structures for alignment control at a position away therefrom becomes small. However, according to the present embodiment, with polymer formed in a layer of liquid crystals and by inserting a gray volt, liquid crystal molecules can be aligned in a predetermined direction within a short period of time, and therefore favorable response characteristics can be obtained even if the panel size becomes large.

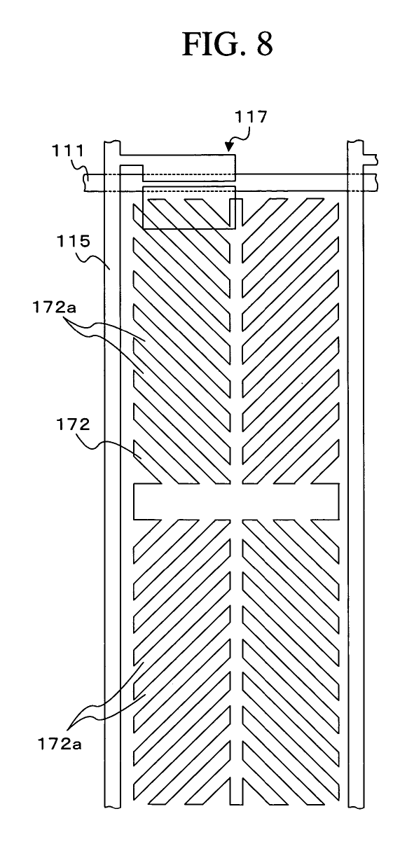

In addition, for example, as shown in FIG. 8, the present invention may be applied to a liquid crystal display device having a picture element electrode 172 which is provided with fine slits 172a extending obliquely and radially from two center lines that perpendicularly cross to each other. Although, in a liquid crystal display device of this kind, liquid crystal molecules are aligned in directions in which fine slits extend, when the widths of fines slits exceed 5 μm, the alignment control property due to the presence of fine slits is lowered. Accordingly, it is preferred that the widths of fines slits be not greater than 5 μm.

Furthermore, in the present embodiment, a gray voltage is applied just during the period of one frame (approximately 16 ms) when changing from a black display to a white display. However, the present invention is not limited to this. For example, for a liquid crystal display device in which display voltages are applied a plurality of times corresponding to one picture element within the period of one frame, the period of applying of a gray voltage may be set shorter than that of one frame.

What is claimed is:

1. A liquid crystal display device comprising:
a first substrate and a second substrate facing to each other;
a layer of liquid crystals formed of liquid crystals being sealed between the first substrate and the second substrate;
pretilt means for tilting liquid crystal molecules in a predetermined direction when no voltage is applied;
an electrode for applying a voltage to the layer of liquid crystals and changing an alignment state of the liquid crystal molecules;
a display signal output section for supplying display signals to the electrode; and
a display signal monitor section for monitoring a change of the display signals for every frame, and for controlling the display signal output section and thus causing the display signal output selection to supply the electrode with a third voltage being a medium one between a first voltage and a second voltage before supplying the second voltage thereto, when a display signal changes from the first voltage to the second voltage being higher than the first voltage.

2. The liquid crystal display device according to claim 1, wherein the first voltage is a black display voltage.

3. The liquid crystal display device according to claim 1, wherein the third voltage is a voltage equivalent to 1 to 10% of transmittance in the period of a white display.

4. The liquid crystal display device according to claim 1, wherein the pretilt means is polymer formed in the layer of liquid crystals.

5. The liquid crystal display device according to claim 1, wherein the pretilt means is an alignment film which is provided to a surface of at least one of the first substrate and the second substrate, and on which a rubbing process is performed.

6. The liquid crystal display device according to claim 1, wherein the pretilt means is an alignment film which is provided to a surface of at least one of the first substrate and the second substrate, and on which an ultraviolet radiation process is performed.

7. The liquid crystal display device according to claim 1, wherein a pretilt angle (an angle formed between a surface of the substrate and the major axis of the liquid crystal molecule) of the liquid crystal molecule by using the pretilt means is not less than 87° and less than 90°.

8. The liquid crystal display device according to claim 1, wherein the liquid crystals are of negative dielectric anisotropy.

9. The liquid crystal display device according to claim 1, wherein a period of time in which the third voltage is applied is not greater than the period of one frame.

10. The liquid crystal display device according to claim 1, wherein a plurality of structures for alignment control are provided to at least one of the first substrate and the second substrate.

11. The liquid crystal display device according to claim 10, wherein the structures for alignment control are protrusions each formed of a dielectric material.

12. The liquid crystal display device according to claim 10, wherein the structures for alignment control are slits provided to the electrode.

13. The liquid crystal display device according to claim 12, wherein the widths of the slits are not greater than 5 μm.

14. The liquid crystal display device according to claim 10, wherein intervals between the structures for alignment control are not less than 25 μm.
